(19) United States
(12) Patent Application Publication
(10) Pub. No.: US 2002/0073411 A1
(43) Pub. Date: Jun. 13, 2002

(54) Controller and application installing method

(76) Inventors: Kunihiko Tsunedomi, Hitachi (JP); Shoji Suzuki, Hitachi (JP); Tsutomu Yamada, Hitachi (JP); Takanori Yokoyama, Hitachi (JP); Masahiko Saito, Mito (JP); Hidemitsu Naya, Hitachi (JP); Satoru Funaki, Hitachi (JP); Hiroshi Arita, Hirachi (JP); Yoshinori Ohkura, Mito (JP); Tetsuaki Nakamikawa, Hitachi (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/791,828

(22) Filed: Feb. 26, 2001

(30) Foreign Application Priority Data
Dec. 8, 2000 (JP) 2000-379753

(51) Int. Cl. G06F 9/445

(52) U.S. Cl. 717/171; 717/176

(57) ABSTRACT

A controller to which a plurality of apparatus can be connected has an apparatus discriminating unit for discriminating a type and/or the number of the apparatus connected to the controller. The controller further has an application discriminating unit for discriminating, based on the type and/or the number of the apparatuses discriminated by the apparatus discriminating unit, an application corresponding to the type and/or the number of the apparatuses.

### BACKGROUND OF THE INVENTION

1. Field of the Invention

The present invention relates to an installing method of an application to a controller used for monitoring and controlling an apparatus, and relates to a controller and a computer both of which use such a method.

2. Description of the Related Art

FIG. 2 shows a construction of a conventional controller. Controller software is constructed by a basic program 9, a driver 5, and an application 8.

The basic program 9 is a portion which is generally called monitor or OS (Operating System). The basic program 9 provides functions for managing hardware of a controller 1 and executing programs (the driver 5 and the application 8 which will be explained hereinafter). When the controller 1 is connected to a network, the basic program 9 provides a protocol of the network. Functions of the OS are described in detail in Akira Nakamura, et al., “Design and Installation of UNIX 4.3BSD”, Maruzen Co., Ltd., p.241.

The driver 5 is a program for controlling control apparatuses 21 and 22. The driver 5 provides the fundamental functions for initializing the control apparatuses 21 and 22 and performing the writing/reading operations into/from the control apparatuses 21 and 22, to the basic program 9 and the application 8. Each of the control apparatuses 21 and 22 has a register for making it operative. The driver 5 performs the writing operation into the register, thereby making the control apparatus 21 or 22 operative. The driver 5 performs the reading operation from the register, thereby confirming the states of the control apparatus 21 or 22. In a general controller, the driver is initially included in the basic program. Therefore, the user of the controller does not need to install the driver. However, in case of adding a new control apparatus to the controller, it is necessary to replace the basic program itself. As a method of solving the above problem, PnP (plug and play) or UPnP (universal plug and play) technique has been introduced in the field of PC (personal computer). That is, there is a method of having an apparatus discriminating unit, and automatically installing the necessary driver 5 by a driver installer 4 based on the discrimination result.

An outline of UPnP will now be described. In UPnP, a protocol, in which a connected device and a computer communicate, has been specified. Both of the connected device and the computer have this protocol therein. The computer can inquire about a type of the connected device (the device type in the UPnP) and a function provided by the connected device (the device service in UPnP), using the protocol. Specifically speaking, the controller multicasts M-SEARCH method of SSDP (Simple Service Discovery Protocol) to the control apparatus. The control apparatus receiving M-SEARCH returns a device number (the name of the control apparatus in the present invention) called UUID. Please refer to “Universal Plug and Play Device Architecture Version 1.0 (the Universal Plug and play Forum in 2000)” about the detailed specification of UPnP.

The application 8 is a program for performing a control which the user wants to execute by combining the control apparatuses 21 and 22. For example, it is assumed that the user constructs an automatic door system which is opened and closed by a card reader 204 (refer to FIG. 4). At this time, like a controller 102 in FIG. 15, the card reader 204 and an automatic door control apparatus 205 are connected to the controller 1. The driver 5 provides the fundamental functions for making the card reader 204 and the automatic door control apparatus 205 operative. The application 8 realizes a control, which the user wants to execute, using the functions of the driver 5. That is, the application 8 reads out the discrimination result of the card reader 204 by a card reader driver. In case of a correct card, the application instructs the automatic door driver to open the automatic door. As mentioned above, the application couples the various drivers and performs a logic control such as “if the card is valid, the automatic door is opened”. The application of the controller is formed by the user using the controller dedicated language such as “ladder”, “function block” or “IL (Instruction Language)”. This language is interpreted by an interpreter and is executed. The application can be an object file which is described in “C language” and converted into an object code by a compiler. In this case, the application is directly executed by a processor. Since the controller dedicated language such as “ladder”, “function block” or “IL” is defined in Takashi Sekiguchi, “Programming of New Programmable Controller”, Corona Co., Ltd., pp.137-209, and in IEC61131-3, please refer to them.

In recent years, since the miniaturization and the low price of the controller have been realized, there is a possibility that the controller is used in an ordinary home in addition to an FA (factory automation) and a building management. Although the user needs to program the application in order to use the controller as mentioned above, the general user does not have much knowledge about the programming languages such as “ladder” and “function block”. Therefore, it is difficult for the general user to program the controller. Thus, it is considered to sell the application using the programming language of the controller and allow the user to install it. However, such a method also has the following problem. The user connects the control apparatuses to many various controllers in accordance with the applications. It is a difficult work for the user to select and purchase the applications in accordance with the combination of them.

### SUMMARY OF THE INVENTION

An object of the present invention is to provide a controller and an application installing method, in which each time a new control apparatus is connected, the user does not need to install an application corresponding to the connected control apparatus.

A first controller according to the present invention is a controller to which a plurality of apparatuses can be connected, and comprises: apparatus discriminating means for discriminating a type and/or the number of apparatuses connected to the controller; and application discriminating means for discriminating, based on the type and/or the number discriminated by the apparatus discriminating means, an application corresponding to the type and/or the number.

The controller may further comprise installing means for installing the application discriminated by the application discriminating means.

When the apparatuses are connected, the apparatus discriminating means may automatically discriminate the type of the apparatus; and the installing means may automatically install the discriminated application.

A second controller according to the present invention is a controller to which a plurality of apparatuses can be connected, and comprises: interface means for connecting to a network; apparatus discriminating means for discriminating a kind of the apparatuses connected to the controller; application discriminating means for discriminating, based on the kind discriminated by the apparatus discriminating means, an application corresponding to the kind; and installing means for inputting the application discriminated by the application discriminating means through the network, and installing the inputted application.

The application discriminating means may include: correspondence recording means for storing correspondence data to which a type and/or the number of the apparatuses and the installed application are corresponded; and selecting means for selecting an application corresponding to the apparatuses connected to the controller based on the correspondence data stored in the correspondence recording means.

The controller may further comprise a storing unit connected to the network, for storing at least an application corresponding to the apparatuses, wherein the controller is connected to the storing unit through the network.

An application installing method according to the present invention comprises the steps of: detecting whether or not apparatuses can be connected to a controller to which a plurality of apparatuses can be connected, and detecting a type and/or the number of the apparatuses; discriminating, when the apparatuses are connected, an application based on the detected type and/or number of the apparatuses; and automatically installing the discriminated application.

### BRIEF DESCRIPTION OF THE DRAWINGS

FIG. 1 shows a construction of a first embodiment of the present invention;

FIG. 2 shows a construction of a prior art;

FIG. 3 shows the relations among an apparatus discriminating unit 3, an application discriminating unit 6 and an application installer 7 in the present invention;

FIG. 4 shows a construction according to an embodiment of the present invention in case where an application and a correspondence table 62 are provided on a computer of a network;

FIG. 5 shows a construction of an apparatus recording unit 63 shown in FIG. 1;

FIG. 6 shows a construction of the correspondence table 62 shown in FIG. 1;

FIG. 7 shows a construction of an embodiment of the present invention in case where the application and the correspondence table 62 are provided on the computer of the network;

FIG. 8 shows a construction of controller hardware;

FIG. 9 shows a construction of an embodiment of the present invention in case where the application discriminating unit 6 and the application are provided on the computer of the network;

FIG. 10 shows a flowchart for the apparatus discriminating unit 3;

FIG. 11 shows a flowchart for the application discriminating unit 6;

FIG. 12 shows a flowchart for the application installer 7;

FIG. 13 shows a ladder program of an automatic door application with authentication 82;

FIG. 14 shows an IL program for the automatic door application with authentication 82; and

FIG. 15 shows a hardware connection construction of an automatic door with authentication.

### DETAILED DESCRIPTION OF THE EMBODIMENTS

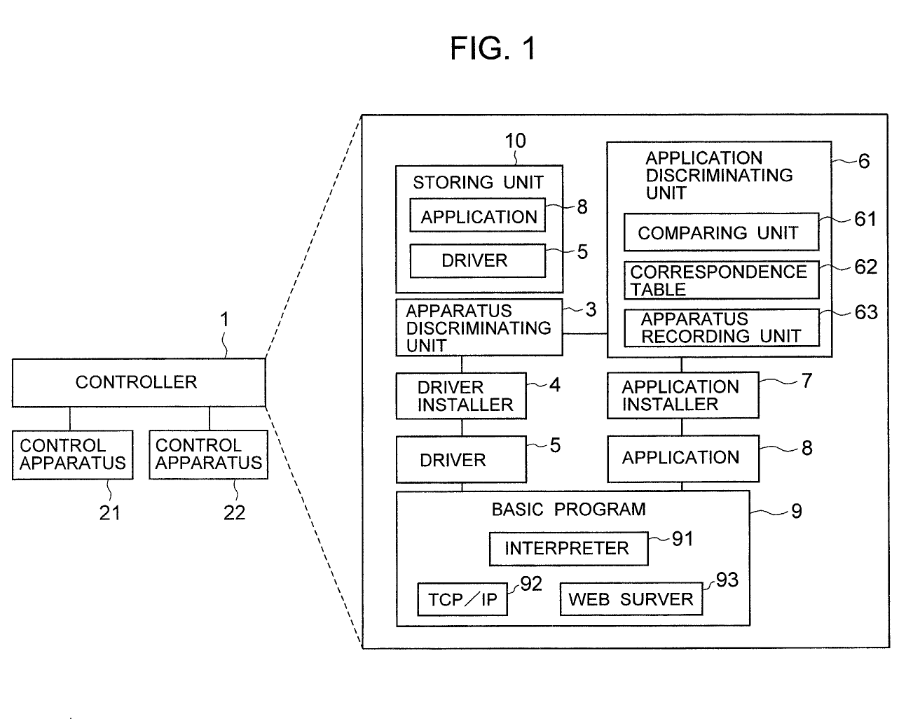

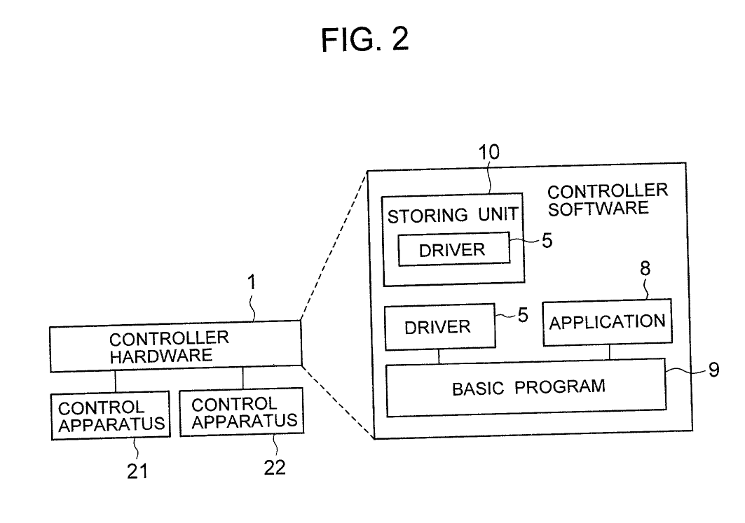

Embodiments will now be described hereinbelow with reference to FIGS. 1-15.

### First Embodiment

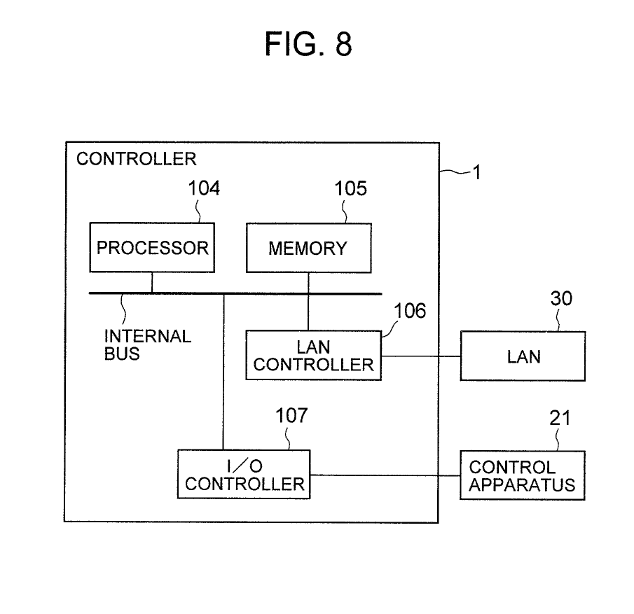

A first embodiment shows an example in which the present invention is embodied by a sole controller. FIG. 1 shows the construction of the embodiment. FIG. 8 shows the construction of controller hardware.

The controller hardware will be described with reference to FIG. 8. The controller 1 includes a processor 104, a memory 105, an I/O controller 107 and a LAN controller 106. The memory 105 stores controller software. The processor 104 reads out programs for the apparatus discriminating unit 3, the driver installer 4, the basic program 9, the application, the application installer 7 and the comparing unit 61 of the controller software, and executes them. The LAN controller 106 is used for connecting to a network. The network may be a wide area network such as WAN, or a network of a small scale such as network in home. The LAN controller 106 sends reception data from the network to the processor 104. The LAN controller 106 receives data, which is sent to the network, from the processor 104, and transfers it onto a network 30. When the network is not used, the LAN controller 106 is unnecessary. The control apparatus 21 is an apparatus controlled by the controller. The control apparatus 21 generally has a buffer called a register, and the writing and reading operations can be performed from the controller 1. As a register, there are two kinds of registers such as status register and control register. The control apparatus 21 operates in accordance with data contents written in the control register, and writes an operation state or an operation result to the status register. As control apparatuses, in the industrial field, there are apparatuses used for a factory automation system such as sensor, inverter, servo amplifier, motor, controller, switch, touch-panel, liquid crystal panel controller and actuator. In the home-use field, there are considered home electric appliances such as video camera, video tape recorder, television set, telephone, interphone, refrigerator, washing machine, cleaner, electronic oven, key of a door, washlet, lighting apparatus, air conditioner, electric kettle, gas kettle, rice cooker and clock. In the office or building management field, there are considered OA (office automation) apparatuses and building management appliances, such as card reader 204, facsimile machine, copy machine, telephone, scanner, personal computer, ammeter, wattmeter and breaker. The I/O controller 107 reflects read/write commands from the processor 104 to the register of the control apparatus 21. In case of the read command, the I/O controller 107 transmits the contents in the register of the control apparatus 21 to the processor 104. In case of the write command, the I/O controller 107 writes data into the register of the control apparatus 21.

The storing unit 10 is an area for storing applications and drivers, and may be a non-volatile memory or a volatile memory. In case of the volatile memory, it is necessary to always supply current by a backup power source.

The storing unit 10 will now be described. If the storing unit 10 is a flash memory or an RAM, it is directly connected to the controller 1. In this case, it is inconvenient to update the applications and the drivers. Therefore, in place of them, it is possible to use a portable recording medium (for example, a detachable flash memory such as PC-card-type flash memory, or a magnetic medium such as floppy disk).

The construction of the controller software will now be described with reference to FIG. 1.

The software of the controller 1 is constructed by an apparatus discriminating unit 3, a driver installer 4, a driver 5, an application discriminating unit 6, an application installer 7, an application 8 and a basic program 9. If there is a LAN controller, communication protocols (for example, TCP/IP 92 and Web server 93) for processing communication with the network are included in the basic program 9.

The apparatus discriminating unit 3 is software for discriminating the kinds (types) of the control apparatuses 21 and 22 connected to the controller 1. The apparatus discriminating unit 3 can perform the discrimination about each control apparatus using the existing technique like UPnP. The apparatus discriminating unit 3 notifies the application discriminating unit 6 of the kinds of the control apparatuses whose connection has been confirmed. Specifically speaking, the apparatus discriminating unit 3 records to an apparatus recording unit 63 the kinds of the control apparatuses whose connection has been confirmed. The apparatus discriminating unit 3 records to the apparatus recording unit 63 the number(s) of the control apparatuses whose connection has been confirmed. When there is the driver installer 4, the apparatus discriminating unit 3 also notifies the driver installer 4 of the type(s) of the control apparatuses whose connection has been confirmed.

The driver 5 prepares a united interface in order to initialize the control apparatus and to use the control apparatus from the application and the basic software. For example, as described in “Design and Installation of UNIX 4.3BSD” described above, the predetermined functions (hereinafter, called “united interfaces”) such as Read (read-out), Write (writing) and ioctl (control) are prepared. A programming is performed so as to call using the functions from the application which uses them. Consequently, even if the driver 5 is dynamically installed by the driver installer 4, it does not occur that the application and the driver 5 cannot be linked, because the function names are different.

The driver installer 4 is software for dynamically installing the driver 5. An installing method of the driver 5 is divided into the following three procedures. First, a memory having a capacity which can record a driver program is allocated. It can be realized using a memory management of the basic program 9. The installer itself may have the memory management. Subsequently, a necessary driver is read out from the storing unit 10, and then is written into the allocated memory. Finally, a function address of the united interface is registered into the basic program 9. In case of statistically linking the driver 5 to the basic program 9, the driver installer 4 is unnecessary. Also in the embodiment, the driver installer 4 is not particularly an essential component element.

The application discriminating unit 6 is a program for selecting the application to be installed into the controller 1. The application discriminating unit 6 includes the apparatus recording unit 63, a correspondence table 62 and the comparing unit 61.

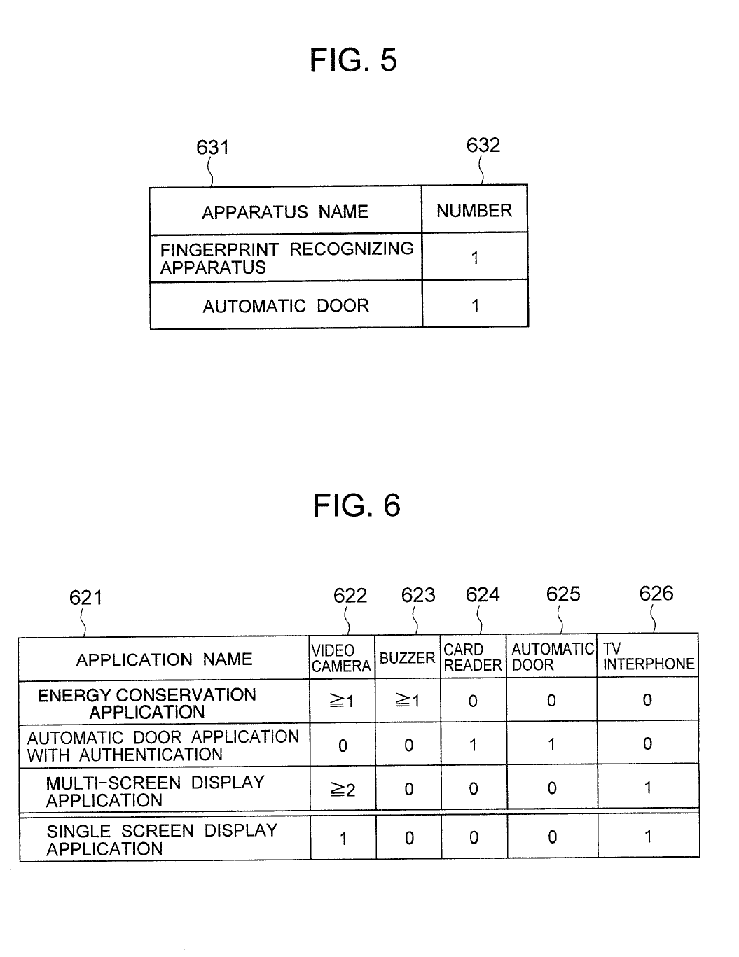

FIG. 5 shows the construction of the apparatus recording unit 63. The apparatus recording unit 63 stores the apparatus name (type) 631 and the number (632) of the connected apparatuses. Although the names of the connected apparatuses are recorded in the apparatus name 631 in FIG. 5, the unique numbers which are previously allocated every apparatus may be stored. They are written into the apparatus recording unit 63 by the apparatus discriminating unit 3.

FIG. 6 shows the construction of the correspondence table 62. The correspondence table 62 is a table having an array of N×M in which an application name 621 and the number of the control apparatuses used by the application are recorded. In the table, N denotes the number of the kinds of the control apparatuses, and M indicates the number of the applications. The numbers of the control apparatuses 622, 623, 624, 625 and 626 and the names 621 of the applications which are installed when each of the control apparatus is connected are recorded in each column. Here, the names of the control apparatuses are recorded on the first column. If the column numbers and the control apparatuses correspond in a one-to-one relationship manner, the names of the control apparatuses are particularly unnecessary. In FIG. 6, although the names of the control apparatuses such as “video camera” and “buzzer” are directly recorded, IDs (numbers) which are previously allocated to the control apparatuses may be used instead. Similarly, instead of the application names 621, IDs (numbers) which are previously allocated to the applications may be used. Although the numerals indicative of the numbers of the control apparatuses are recorded on each of the 2nd to Nth rows, the numerical value ranges such as “≧1”, “≦2” and “0≦No.≦2” other than the numerals can be recorded.

The comparing unit 61 shown in FIG. 1 is a program to select an application to be installed into the controller 1. The comparing unit 61 reads out the type(s) and the number(s) of the current control apparatuses from the apparatus recording unit 63, and searches from the correspondence table 62 the application(s) with which the conditions of the control apparatuses are matched.

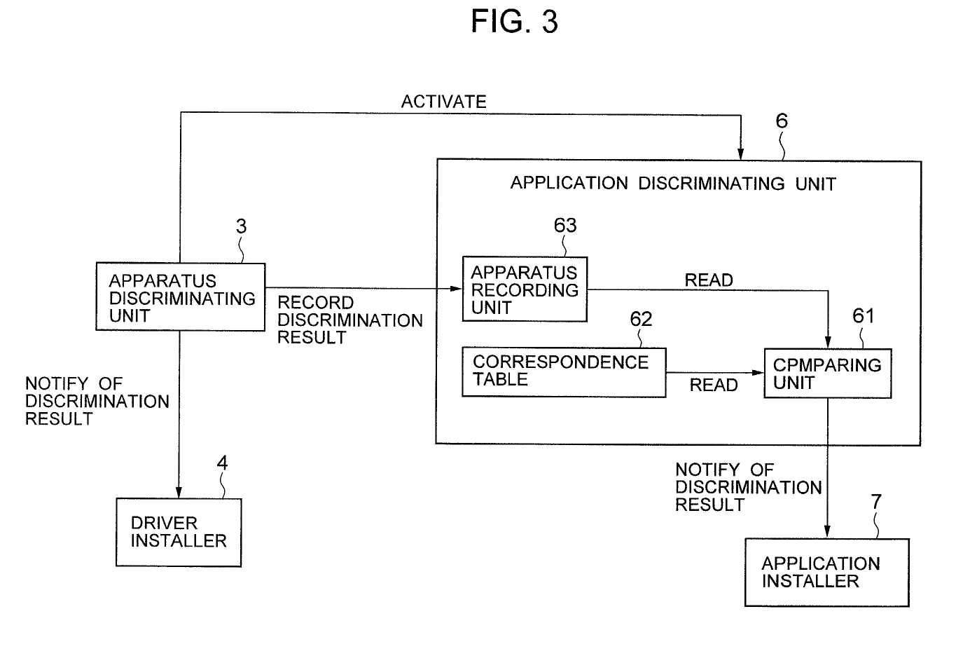

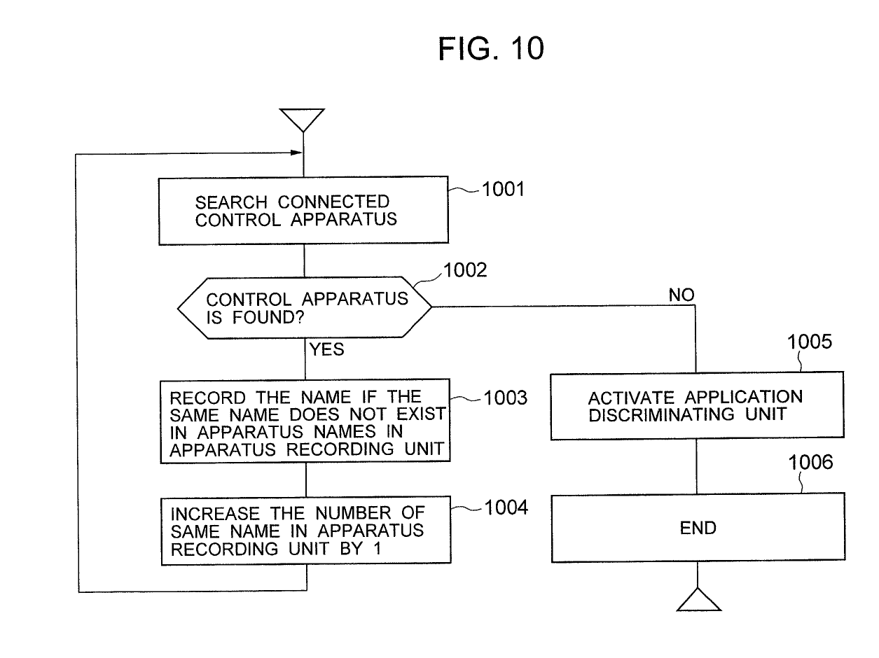

FIG. 3 shows the relations among the apparatus recording unit 63, the correspondence table 62 and the comparing unit 61. The data is written into the apparatus recording unit 63 by the apparatus discriminating unit 3, and read out from the apparatus recording unit 63 by the comparing unit 61. The correspondence table 62 is previously initialized and is read out by the comparing unit 61. These operations will be explained with reference to a flowchart of FIG. 10 hereinafter.

The application installer 7 shown in FIG. 1 is a program for installing dynamically an application. The installing procedure of the application is divided into the following two procedures. First, a memory having a capacity which can record an application program is allocated. This process can be realized using the memory management of the basic program 9. The application installer 7 itself may have the memory management. A necessary application is read out from the storing unit 10 and is written into the allocated memory.

The application 8 is a program for performing a logical control which the user wants to execute by combining the control apparatuses. The application of the controller 1 is described in the object codes which can be directly executed by the processor 104 (see FIG. 8), or is described in the language of the interpreter 91 such as ladder language. In case of the interpreter language, the interpreter 91 included in the basic program 9 interprets the application and converts it into object codes. Then, the processor 104 executes the application. In the following operation explanation, although a case where the application is described in the ladder language is handled, there is not a fundamental difference except for a way of executing the application. In case of making the control apparatus operative from the application, the function of the driver 5 is called and the operation is controlled. The driver 5 can be called by obtaining an address of the driver function through the basic program 9.

The automatic installing operation of the application will now be described with reference to flowcharts of FIGS. 10-13.

FIG. 10 shows the flowchart for the operation of the apparatus discriminating unit 3. In the embodiment, the apparatus discriminating unit 3 automatically starts the operation when the power source of the controller 1 is turned on. However, in an embodiment in which a reset button is provided for the controller 1, the apparatus discriminating unit 3 can be executed every reset.

When the execution is started, the apparatus discriminating unit 3 first searches the connected control apparatuses (step 1001). The search of the control apparatuses can be realized by the conventional technique. For example, in UPnP, the controller 1 multicasts M-SEARCH method of SSDP (Simple Service Discovery Protocol) to the control apparatuses 21 and 22. Each of the control apparatuses 21 and 22 receiving M-SEARCH returns the device number called UUID (the name of the control apparatus in the present invention). Thus, the connected control apparatuses can be searched.

Subsequently, the apparatus discriminating unit 3 discriminates whether or not any control apparatuses are found (step 1002). If a control apparatus is found, it is discriminated whether or not the control apparatus of the same name is recorded in the apparatus recording unit 63. If the control apparatus of the same name is not recorded, the name of the control apparatus is newly recorded (step 1003). If the control apparatus of the same name is recorded, the number of the control apparatus in the apparatus recording unit 63 is increased by “1” (step 1004). After that, the processing routine is returned to step 1001 in order to search another control apparatus.

If a control apparatus cannot be newly found in step 1002, the application discriminating unit 6 is activated (step 1005). After that, the apparatus discriminating unit 3 is stopped (step 1006). One of the methods of activating the application discriminating unit 6 uses the function of the basic program 9 to form the application discriminating unit 6 as a task (or process) to start the execution.

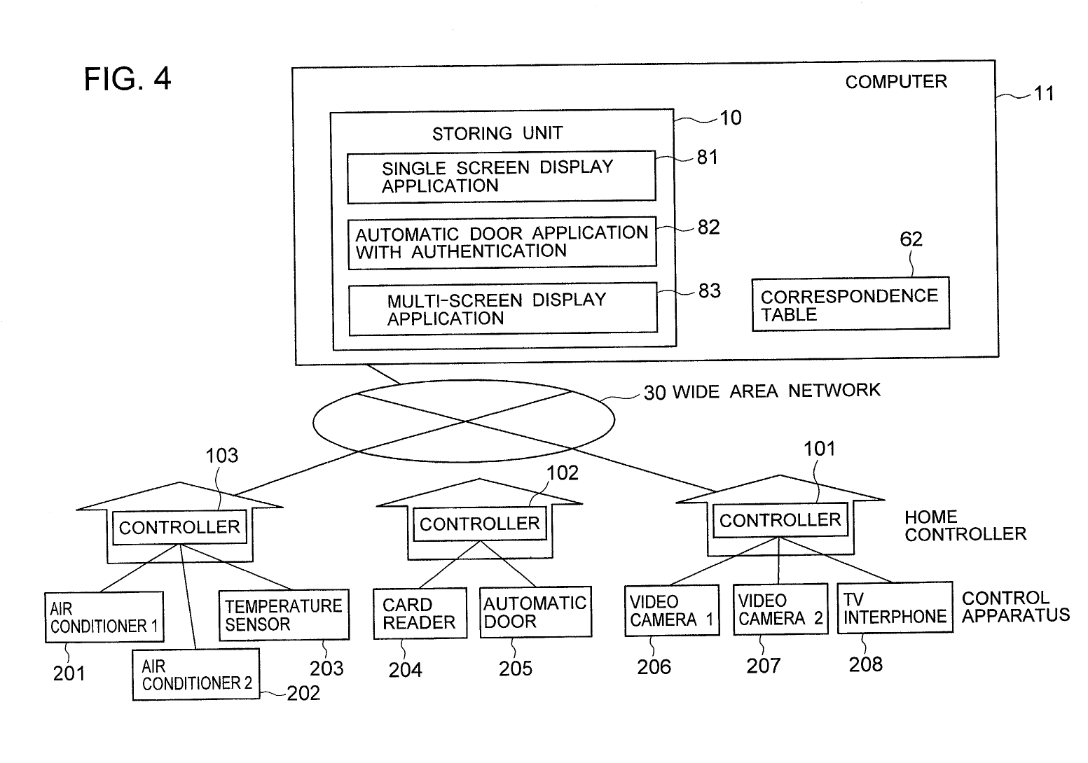

The recording into the apparatus recording unit 63 is completed by the foregoing processes of the apparatus discriminating unit 3. For example, in the controller 102 shown in FIG. 4, the contents shown in FIG. 5 are recorded in the apparatus recording unit 63.

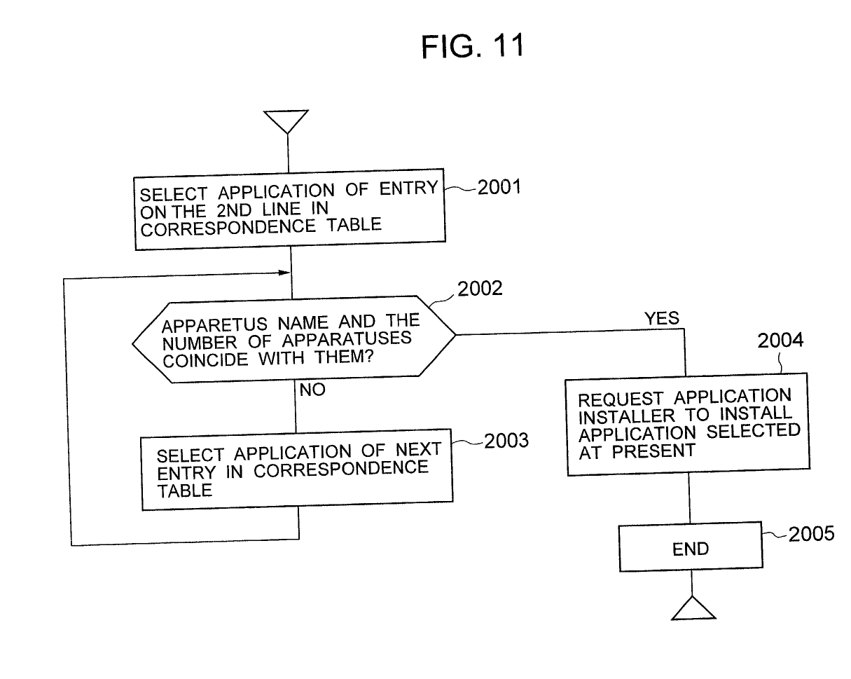

FIG. 11 shows the flowchart for the application installer 7. The application installer 7 is activated from the apparatus discriminating unit 3. First, the application installer 7 selects the second entry (the entry of an energy conservation application in the embodiment shown in FIG. 6) in the correspondence table 62 (step 2001). Subsequently, it is discriminated whether or not the type and the number of the control apparatuses of the selected entry and those in the apparatus recording unit 63 coincide (step 2002). If they do not coincide, the next entry in the correspondence table 62 is selected (step 2003), and the processing routine is returned to step 2002. If the type and the number of the control apparatuses coincide with those in the apparatus recording unit 63 in step 2002, the currently selected application is selected as an application to be installed, and the installation is requested for the application installer 7 (step 2004). After that, the process of the application discriminating unit 6 is terminated (step 2005). As means for realizing the request for the application installer 7, there is one for using the function of the basic program 9 to form the application installer 7 as a task (or process) to start the execution.

The selection of the application is completed by the process of the apparatus discriminating unit 3 as mentioned above. For example, if the correspondence table 62 of the controller 102 shown in FIG. 4 is as shown in FIG. 6, since the number of the control apparatuses coincides with “automatic door application with authentication”, an automatic door application with authentication 82 is selected.

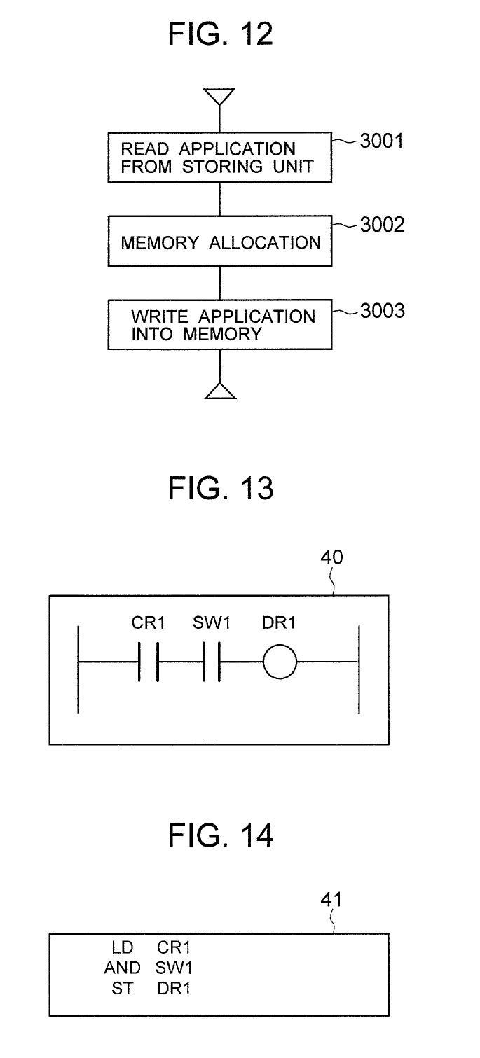

FIG. 12 shows the flowchart for the application installer 7. The application installer 7 is activated by the application discriminating unit 6. First, the application installer 7 reads out the application from the storing unit 10 (step 3001). Subsequently, the size of the application is measured, and the memory of the similar size is allocated (step 3002). The application read in step 3001 and the size measurement in step 3002 are realized by the file system of the basic program 9. The memory allocation in step 3002 is realized by the memory management system call of the basic program 9. After completion of step 3002, the application is written into the allocated memory, and then the processing routine is terminated (step 3003).

Subsequently, the operation of the application installed by the application installer 7 will be described. The automatic door application with authentication 82 shown in the explanation on FIG. 1 will be described as an example.

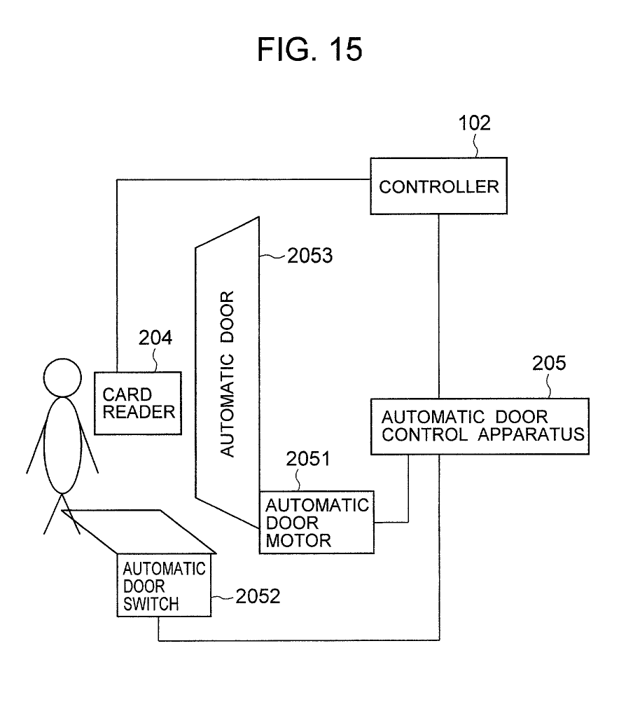

FIG. 15 shows the construction of the control apparatus controlled by the automatic door application with authentication 82. The card reader 204 and the automatic door control apparatus 205 are connected to the controller 102. An automatic door motor 2051 and an automatic door switch 2052 are connected to the automatic door control apparatus 205. The automatic door switch 2052 is built in a mat in front of the door. When a passer stands on the mat, the automatic door switch 2052 is turned on, so that the automatic door motor 2051 opens the automatic door 2053 only for a predetermined period of time.

FIG. 13 shows the ladder program of the automatic door application with authentication 82. This program controls so as to open the automatic door 2053 when the automatic door switch 2052 is ON and the card reader 204 recognizes that the card as a legal card. In the program, CR1 denotes the status of the card reader 204. If the card read out by the card reader 204 is the legal card, the status CR1 is set to “1”. If the card is an illegal card, the status CR1 is set to “0”. SW1 denotes the status of the automatic door switch 2052. When the automatic door switch 2052 is ON, the status SW1 is set to “1”. When the automatic door switch 2052 is OFF, the status SW1 is set to “0”. DR1 denotes the command to open the door. When the command DR1 is set to “1”, the automatic door motor 2051 opens the automatic door 2053.

When the automatic door application program with authentication 82 is interpreted by the ladder grammar, it means “the logical AND of CR1 and SW1 is got to be written into DR1”. Although the interpreter 91 interprets and executes it, it will be explained using a program (see FIG. 14) obtained by converting it into IL for convenience of explanation of the operation of the interpreter 91.

The operation of the interpreter 91 when the automatic door application program with authentication 82 is executed will be described hereinbelow. The interpreter 91 reads out the first command (LD CR1). LD denotes a command for loading CR1 into an accumulator. Therefore, the interpreter 91 reads out CR1 using the “read” function of the automatic door driver and writes it into the accumulator. Subsequently, the interpreter 91 reads out the second command (AND SW1). AND denotes a command for getting the logical AND of the accumulator and SW1 to store the result into the accumulator. Therefore, the interpreter 91 reads out SW1 using the “read” function of the driver of the card reader 204, gets the logical AND of SW1 and the accumulator, and writes the result into the accumulator. Finally, the interpreter 91 reads out the third command (ST DR1). ST denotes a command for storing the accumulator into DR1. Therefore, the interpreter 91 writes the contents of the accumulator into DR1 using the “write” function of the automatic door driver. By the above operation of the interpreter 91, it will be understood that DR1 is set to “1” only when CR1 and SW1 are set to “1”.

### Second Embodiment

Although the first embodiment is described as an example with respect to the case where the application is the automatic door application with authentication 82, it shows only the control apparatus which does not use the other applications as shown in FIG. 6. Therefore, when the application is selected, it is sufficient that the application discriminating unit 6 compares only the apparatus recording unit 63 with the apparatus names in the correspondence table 62. Specifically speaking, it is possible to delete step 1004 and change step 2002 to step “whether or not the apparatus name coincides?”.

On the contrary, it is necessary to examine both the apparatus name and the kind in case where a plurality of applications use the apparatus having the same name. For example, in case where two video cameras 206 and 207 and a TV interphone 208 are connected to the controller like a controller 101 shown in FIG. 4 and the video images of the video cameras 206 and 207 are displayed on the TV interphone 208, an application to be installed differs in dependence on the number of the video cameras. When there is one video camera, a “single screen display application 81” for displaying only one screen to the TV interphone is installed. When there are two video cameras, a “multi-screen display application 83” for displaying two or more screens to the TV interphone is installed.

### Third Embodiment

When the number of the types of the control apparatuses connected to the controller (or the control apparatuses supported by the application discriminating unit 6) increases, N in the correspondence table 62 increases. Therefore, each time N increases, it is necessary to update the correspondence table 62. When the number of the control apparatuses to be supported increases, the number of the applications for supporting increases. If the updating of the correspondence table 62 or the addition of the application is executed every controller, the cost rises.

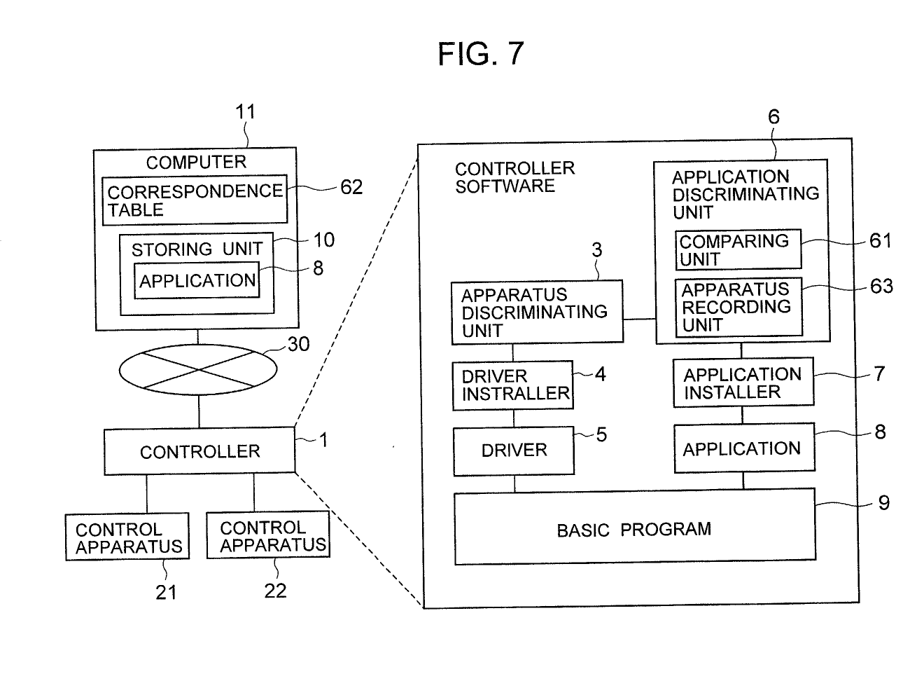

As an embodiment for solving such a drawback, as shown in FIG. 7, there is a method in which the application 8 and the correspondence table 62 are put on the computer on the network and those data are shared by a plurality of controllers. The data sharing can be realized using a network file system. The network file system is a technique for enabling a file of the computer on the network to be read out and written using a system call which is used for a file on the own computer. If the network file system is used, the correspondence table 62 application of the computer can be read out and written from the application discriminating unit 6 and the application installer 7 without being aware of the network. When the control apparatuses and the applications which are supported increase, it is sufficient to merely change the correspondence table 62 and the application 8 of one computer 11. There is no need to change the application installer 7, the apparatus discriminating unit 3 and the application discriminating unit 6.

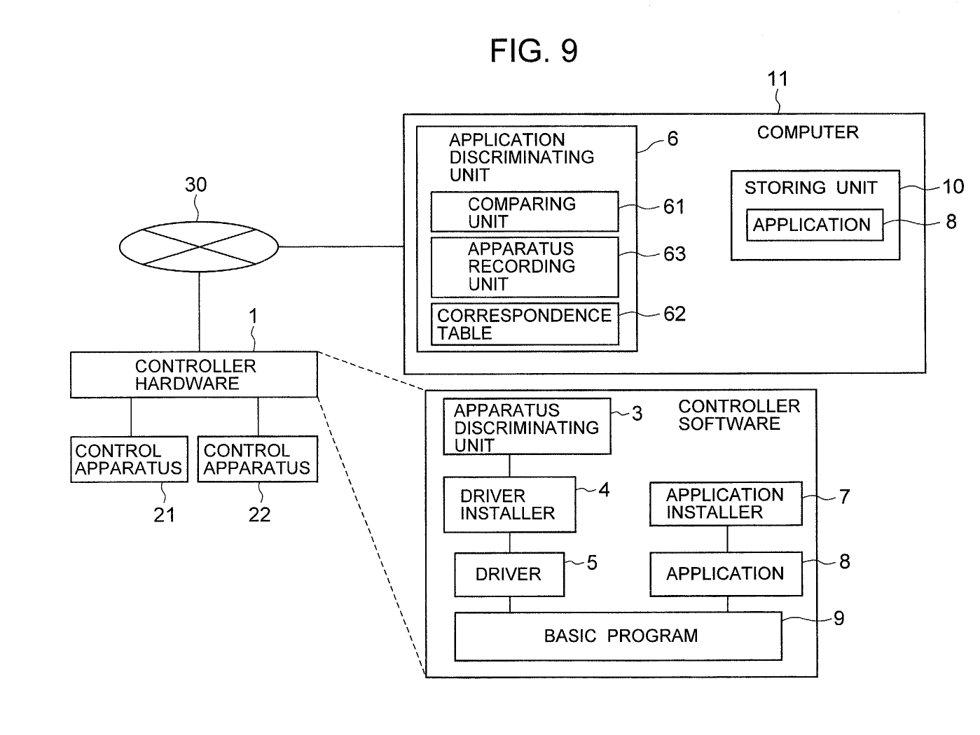

As another solving method, as shown in FIG. 9, there is a method in which the whole application discriminating unit 6 is provided on another computer 11 and the application discriminating unit 6 is used from the controller 1. In this case, the activation of the application discriminating unit 6 from the apparatus discriminating unit 3 and the activation of the application installer 7 from the application discriminating unit 6 cannot be realized according to the method of the first embodiment. Therefore, those activating processes are replaced with a remote procedure call. The remote procedure call is a technique for calling a system call for another computer on the network from the own computer. By the remote procedure call, the application discriminating unit 6, the apparatus discriminating unit 3 and the application installer 7 can be called without being aware of a fact that they exist in the different computers, respectively.

### Other Embodiments

The application discriminating unit 6 according to the first embodiment always determines only one application to be installed based on the type and the number of the apparatuses. However, there may be applications in which the type and the number of the apparatuses to be used are the same, in dependence on the applications. In this case, the application discriminating unit 6 according to the first embodiment cannot determine the application.

To solve such a problem, it can be considered to modify the application discriminating unit 6. That is, an output device (for example, a monitor) and an input device (for example, a keyboard or a mouse) are connected to the controller 1. If there are the applications in which the type and the number of the apparatuses are the same, the application discriminating unit 6 displays all of the application names to the output device to allow the application selected by the user to be inputted from the input device. Although the user selects the application, since the number of the selection items is narrowed down, such a selecting work is relatively easy.

What is claimed is:

1. A controller to which a plurality of apparatuses can be connected, comprising:
apparatus discriminating means for discriminating a type and/or the number of said apparatuses connected to said controller; and
application discriminating means for discriminating, based on said type and/or said number discriminated by said apparatus discriminating means, an application corresponding to said type and/or said number.

2. A controller according to claim 1, further comprising:
installing means for installing said application discriminated by said application discriminating means.

3. A controller according to claim 1, wherein
said apparatus discriminating means automatically discriminates the type of said apparatuses when said apparatuses are connected; and
said installing means automatically installs said discriminated application.

4. A controller to which a plurality of apparatuses can be connected, comprising:
interface means for connecting to a network;
apparatus discriminating means for discriminating a kind of said apparatuses connected to said controller;
application discriminating means for discriminating, based on said kind discriminated by said apparatus discriminating means, an application corresponding to said kind; and
installing means for inputting through said network said application discriminated by said application discriminating means, and installing said inputted application.

5. A controller according to claim 4, wherein said application discriminating means includes:
correspondence recording means for storing correspondence data to which a type and/or the number of said apparatuses and said installed application are corresponded; and
selecting means for selecting an application corresponding to said apparatuses connected to said controller based on correspondence data stored in said correspondence recording means.

6. A controller according to claim 4, further comprising:
a storing unit connected to said network, for storing at least an application corresponding to said apparatuses,
wherein said controller is connected to said storing unit through said network.

7. An application installing method comprises the steps of:
detecting whether or not apparatuses can be connected to a controller to which a plurality of apparatuses can be connected, and detecting a type and/or the number of said apparatuses;
discriminating, when said apparatuses are connected, an application based on said detected type and/or number of said apparatuses; and
automatically installing said discriminated application.
